(19) United States
(12) Patent Application Publication
(10) Pub. No.: US 2002/0065197 A1
(43) Pub. Date: May 30, 2002

(54) Heat sensitive recording material

(76) Inventors: Rong-Chang Liang, Newton, MA (US); Donna DeVincent, Bryantville, MA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/006,320

(22) Filed: Dec. 4, 2001

Related U.S. Application Data
(63) Continuation of application No. 09/493,323, filed on Jan. 28, 2000.

(51) Int. Cl. B41M 5/40

(52) U.S. Cl. 503/226

(57) ABSTRACT

Heat sensitive recording sheets for thermal imaging are disclosed comprising a transparent support sheet having a thermal slip layer disposed on one surface of the support and a heat sensitive color-producing layer on the opposite surface of the support. A second opaque (paper) or transparent (plastic) sheet is laminated to the color-producing layer. The recording sheets are suitable for use in high speed thermal printing applications such as computer print out paper, battery operated printers for digital camera or personal digital assistance, stickers and labels, medical imaging, and color proofing films.

### BACKGROUND OF THE INVENTION

1. Field of the Invention

This invention pertains generally to heat sensitive recording materials, and more particularly to high quality heat sensitive recording media used in high-speed thermal printers

2. Description of Related Art

Heat sensitive record images are made by using physical or chemical changes that occur to objects due to thermal energy, and a great number of processes have been studied for these materials. One type of a heat sensitive recording material that uses a physical change of an object caused by heat has long been known as “wax type” heat sensitive recording paper Another type of heat sensitive recording material utilizes a heat induced chemical change, and a typical example includes a two-component color forming system heat sensitive recording sheet. This sheet is made by coating a base with a dispersion of fine particles that include two heat-reactive compounds that are separated from each other by a binder or the like, or which are each segregated in adjacent color layers. One or both of the compounds are melted in image configuration so that they contact each other and cause a color forming reaction by which a record is produced. The two heat-reactive compounds are generally called electron donor and electron acceptor compounds. A great number of combinations of these compounds are known. Typically, known recording materials have a thermally imageable layer (color producing layer) comprising a binder, a colorless or pale leuco dye, and an acidic substance that causes the dye to change color on the application of heat.

The two-component heat sensitive recording media may be single sheet or two sheets It may have a texture similar to that of plain paper and is easy to handle. In addition to these advantages, the use of colorless leuco dyes having high melting temperature permits easy manufacture of heat-sensitive recording sheets forming various hues of color with high density and low fog. For these reasons, the two-component color forming system heat sensitive recording material is most commonly used as heat sensitive recording paper.

The heat-sensitive recording sheets having the unique features described above have been widely used in point of sell printers and facsimile machines The fact that the recording paper is the only consumable is an advantage with respect to the maintenance of the equipment and the printer can be lightweight and miniaturized. However, the use of such a sheet has been disadvantageous in that it relies on thermo-recording, also referred to as direct thermal printing, and therefore has a relatively slow recording speed, particularly for high density images. In order to carry out high-speed recording, a large amount of heat energy must be applied on the heat sensitive recording paper in a short amount of time. However the recording element has a limited recording energy depending on the power of the source in order to subjugate this defect, various means have been devised to increase the recording speed including disposing the thermal printing head as close to the paper as possible. To improve printing speed and reduce printing defects due to uneven dragging at the printer head-paper contact point, surface treatment and additives to improve smoothness and reduce coefficient of friction have been used. Additives such as wax, zinc stearate, and steramide have been commonly used to reduce coefficient of friction. However, those additives tend to transfer to the thermal head and cause undesirable contamination to the head and printing defects

One example to improve the surface smoothness of the heat sensitive recording paper involves calendering processing. However, such a surface processing sometimes causes fog or undesired coloration in the recording paper. U.S. Pat. No. 4,466,007 seeks to eliminate the fogging problem by using a high gloss calendered paper as the base to which the color-producing layer is applied. However, calendering, whether carried out before or after application of the color-producing layer to the paper, is a slow speed process which adds considerable expense to the manufacture of a recording material.

Another approach to improve printing sensitivity and quality involves the further application of a “protective” layer overlying the color producing layer, which protective layer serves a dual function of protecting the thermally produced image from attack by fats, oils, and grease occasioned by routine handling and also provides a reduction in frictional or dragging forces which may exist between the printing surface of the recording paper and the thermal printing head. Typical protective layers are based on polymer compositions comprising a water soluble cross-linkable binder polymer such as a polyvinyl alcohol, silane modified polyvinyl alcohol, carboxylated polyvinyl alcohol, a cross-linking agent such as melamine-formaldehyde and borax, and slip agents such as waxes, silicone, fluorinated polymers, fatty acid soaps and the like. Other protective layers are based on mixtures of water-soluble polymers such as polyvinyl alcohol, fillers and slip agents. Examples of recording paper containing such protective layers may be found in U.S. Pat. Nos. 4,370,370, 4,388,362, 4,885,271, and 4,898,849 In U.S. Pat. No. 5,851,951, heat sensitive recording materials are disclosed comprising a transparent support, at least two color producing layers disposed on a surface of the support and a protective layer overlying the color layers.

Deficiencies associated with such recording materials include the fact that some protective layers are formulated to contain ingredients such as fillers which can detract from the sharpness and clarity of the color images underlying such layers. Another deficiency associated with the water based protective overcoat is the humidity sensitivity and poor resistance to aqueous solutions including juices and coffee. Still another deficiency in the case where paper is the substrate to which the color producing layer is applied is that the matte surface of the paper tends to absorb the aqueous or organic solvent composition applied to the paper in varying degrees, thereby resulting in an image which contains areas of varying or poor density. Such “fizzy” or poor density images lack the photographic quality desired in many printing applications.

### SUMMARY OF THE INVENTION

With the foregoing background of this invention in mind, it is an object of this invention to provide a heat sensitive recording material having good heat response characteristics with a smooth and glossy surface that also enables high-speed recording of durable, high quality images having high color density with little printing defect.

In accordance with the present invention, a heat sensitive recording sheet is provided comprising: a first support layer comprising transparent sheet material; a thermal slip layer disposed on one surface of said first support layer; a heat sensitive color-producing layer disposed on the opposite surface of said first support layer; and a second opaque or transparent sheet material bonded to said heat sensitive color-producing layer

In another embodiment of the invention, an adhesive layer may be interposed between said color-producing layer and said second sheet material.

The invention further provides a heat sensitive recording sheet comprising a) a first support layer comprising transparent sheet material; b) a thermal slip layer disposed on one surface of said first support layer; c) a heat sensitive color-producing layer disposed on the opposite surface of said first support layer; said color-producing layer comprising a leuco dye and an acidic developer dispersed in a thermoplastic polymer binder; d) an adhesive layer disposed on the surface of said heat sensitive color-producing layer opposite said first support layer; and e) a second opaque or transparent sheet material bonded to said adhesive layer, at least one of said color-producing layer and said adhesive layer containing a compound having a melting point of at least about 80° C. which is a solvent for said leuco dye and/or said developer after melting.

The invention also provides a process for producing such recording sheets comprising: applying a coating composition having slip properties to one surface of a transparent sheet material to form a thermal slip layer, applying a coating comprising heat sensitive color-producing composition to the opposite surface of said sheet material to form a heat sensitive color-producing layer; and adhesively bonding a second opaque or transparent sheet material to said heat sensitive color-producing layer.

In the above arrangement, the first support layer serves the dual function of both a protective layer for the underlying color-producing layer and a smooth support surface to which the underlying color-producing layer is applied, thereby enhancing image quality as compared with conventional recording sheets where the color-producing layer is applied directly to opaque substrates such as paper. With such an arrangement, a heat sensitive recording material is provided having good heat response characteristics and a smooth surface that enables high-speed recording. Furthermore, the above structure provides material flexibility with environmental stability and the first support layer also protects the inner layers from blocking, fading and discoloration caused by exposure to materials such as fat, oil, plasticizer, moisture, and fingerprints. Still further, with such an arrangement, the heat sensitive color-producing layer is physically separated from the thermal head, and therefore contamination of the head by dyes and other ingredients present in layer is not possible. The thermal head will not drag on the surface of the recording media by virtue of the presence of the thermal slip layer, thereby further facilitating high speed printing of high quality image with little printing mark or defects caused by the printing head. Still further, compared with coating the color-producing layer directly onto paper recording media prepared by the process of this invention shows a less permeation of the leuco dye or developer into paper and a higher and more uniform coverage at the printing side of the media. Higher color density and printing sensitivity is thus easily achieved

### BRIEF DESCRIPTION OF THE DRAWINGS

FIG. 1 is a schematic cross-sectional view of a recording sheet in accordance with this invention.

FIG. 2 is a schematic cross-sectional view of a different embodiment of a recording sheet in accordance with this invention.

### DETAILED DESCRIPTION OF THE INVENTION

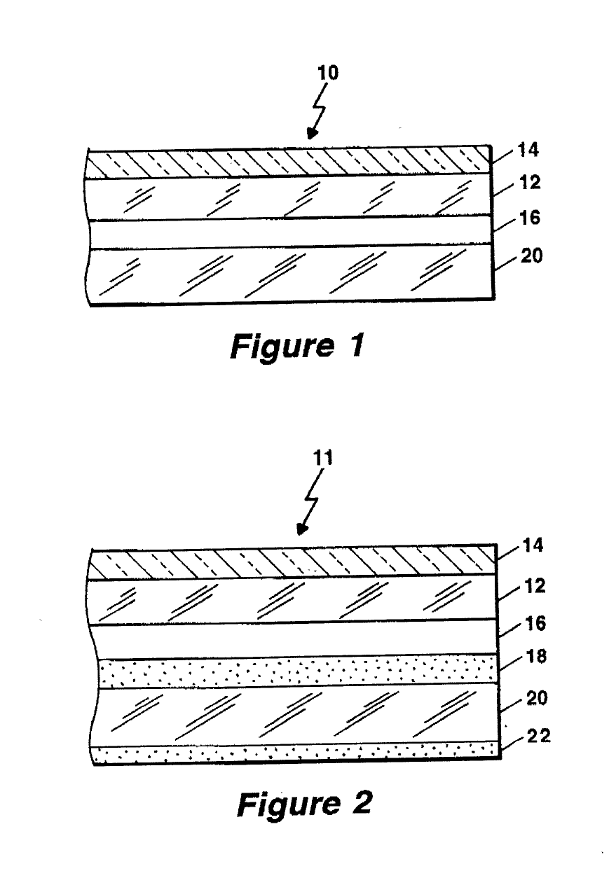

Referring to FIG. 1, recording sheet 10 is shown to include a first transparent support sheet 12 having a thermal slip layer 14 disposed on one surface and a color-producing imaging layer 16 disposed on the opposite surface A second opaque or transparent sheet material 20 is bonded to imaging layer 16.

Referring to FIG. 2, another embodiment shows recording sheet 11 including structures 14, 12, 16, and 20 as described above except that an adhesive layer 18 is interposed between imaging layer 16 and the second sheet material 20 Adhesive layer 18 may also contain heat sensitive color chemicals as described hereafter. Pressure sensitive adhesive layer 22 with or without a peelable backing layer is shown adjacent the outer surface of sheet layer 20.

Transparent sheet material which may be used in fabricating the heat sensitive recording sheet is suitably selected from plastic films or transparent papers having a thickness from about 0.5 to 50 microns, more preferably from about 2 to 20 microns and most preferably from about 3 to 8 microns. The plastic film to be used is not limited. Particularly useful are synthetic resin transparent films including polyethylene terephthlate, polybutylene terephthalate, polyethylene naphthalate and other polyester films, polycyclic olefin films, polycarbonate film, polyamide film, polysulfone film, polyether sulfone film, polyether ketone film, polyether imide film, polyphenylene sulfide film, polyester ether film, polyamideimide film, fluorocarbon resin film, polyurethane film, acrylic film and others. These films can be used singly, or as affixed to one another. The preferred film material is polyethylene terephthlate (PET) film which is biaxially oriented during film manufacture.

Films which have been pretreated (sub coated) on one or both sides by the film manufacturer by primer coatings (thickness of 0.05 to 0.15 microns) which impart hydrophilic properties to the film surfaces are especially useful. Such primer coatings include acrylic or methacrylic acid and/or ester copolymers, polyurethanes, polyvinyl acetate, polyvinyl alcohol and like hydrophilic materials. Such primer coatings enhance adhesion of certain coatings subsequently applied to the film surface.

A thermal slip layer (14) is applied to one surface of the transparent sheet material (12) The purpose of this layer is to reduce friction or dragging of the film surface as it passes by in close proximity to or in contact with the thermal printing head during the printing process. Suitable materials are those which are relatively stable and do not become tacky at printing head temperatures of about 200°-400° C. and which serve to lower the kinetic friction coefficient between the recording sheet and the printer head to a value of less than 0.35, preferably less than 0.25. Suitable slip materials include waxes, polysiloxanes (silicone oil), phosphoric acid esters, fatty acid salts, long chain fatty acid esters or amides, fluorinated polymers such as polytetrafluoroethylene (Teflon®), silicon containing polymers such as acrylic silicon graft copolymers, graphite powders and like materials. These materials may be applied directly to the film surface as solutions or dispersions in water or organic solvents and dried.

In many cases it is desirable to use these slip agents in combination with a binder resin composition to form slip layers which improve the thermal stability of the recording sheet surface. Suitable thermally stable binders are crosslinkable polymers which are formulated with a suitable crosslinking agent such that a thermoset slip layer is formed after the composition is applied to the transparent sheet material and dried at elevated temperatures. Suitable polymers are those containing free hydroxy groups which are crosslinkable using polyisocyanates such as toluene diisocyanate, or polymers containing free acid groups which are crosslinkable using polfunctional amines such as melamine or urea. Suitable such polymers include cellulose acetate, cellulose acetate butynate, cellulose acetate propionate, polyester urethanes, polyvinyl butyral, urethane or epoxy prepolymers and like materials Polymers curable by UV or electron beam radiation may also be used, as well as polymers from monomers which are photopolymerizable, such as epoxy acrylates. The binder-containing slip layer may contain from about 1 to about 35% by weight of the slip agent on a dry weight basis, more preferably from about 5 to 30% by weight. The balance of the layer contains the binder polymer, the crosslinking agent, if present, and 0-20% by weight of other conventional additives such as antistatic agents, fillers, antioxidants and the like.

These binder-containing slip layers containing a mixture of polymer, one or more slip agents described above, appropriate crosslinking agents and other conventional additives dissolved or dispersed in suitable organic solvent or water may be applied as a solution to the surface of the transparent sheet material and dried at a temperature in the range of about 50°-150° C. sufficient to form a thermoset coating layer on the film surface These binder-containing slip layers may be applied at a dry coating thickness in the range of about 0 1 to 5 microns, or a dry coating weight of 0.1 to 5 grams of solids per square meter Advantageously, the slip layer is applied to and cured on the surface of the first support layer prior to application of the color-producing layer as described below, since this eliminates the possibility of heat-induced color-producing reactions from taking place.

Slip layers of this type which are used as back coatings in thermal transfer printing materials are more completely disclosed in U.S. Pat. Nos. 4,950,641, 5,130,293, 5,277,992, and 5,372,988, the complete disclosures of which are incorporated herein by reference.

A color-producing layer (16) hereafter referred to as an image layer, is applied to the surface of the transparent sheet material (12) opposite slip layer (14). This image layer may consist of a single layer or may comprise two or more separate layers disposed adjacent one another. This layer contains the chemistry by which dark or colored images are formed within the layer as a consequence of the selective image-wise heating of the layer by the thermal dye head, and are distinct from the ink layers used in ink transfer sheets which are transferred from the substrate sheet to a print surface either physically or by sublimation of the ink Generally, the image layer may be the conventional layers known in the art

In the single layer configuration, the layer comprises a mixture of suitable binder, preferably a latex polymer or a water soluble polymer, a particulate chromogenic compound such as a colorless, pale or light-colored leuco dye and an acidic compound which reacts with the dye when the materials are liquefied and flow in mutual contact by the application of heat. The layer may also contain a water insoluble, particulate material such as TiO₂ and CaCO₃ The latter also serves as an acid neutralizing agent.

The dye used in the image layer may be of the type generally known in the art which is activated by contact with a heat fusible proton donating (acidic) or electron accepting developer. The preferred leuco dyes are fluoran, lactone, triarylmethane phthalide, leuco triarylmethanes, thiazine, oxazine, or phenazine leuco dyes such as crystal violet lactone, 3-N-cyclohexyl, N-methyl-amino 6-methyl-7-anilino fluoran, 3-pyrrolidino-6-methyl-7-anilino fluoran, 3,3-bis (4-dimethylaminophenyl)phthalide, 6′(dipentylamino)-3′-methyl-2′(phenylamino)-spiro[isobenzofuran-1(3H), 9′-9[9H]xanthen]-3-one,3,3-Bis(butyl-2-methyl-1H-indol-3-yl)-1-[3H]-isobenzofuranone, 2-phenylamino-3′-methyl-6′-(dibutylamino)-spiro[isobenzofuran-1(3H)-xanthen]-3-one,3-[Butyl-2-methylindol-3-yl]-3-(1-octyl-2-methylindol3-yl)-1(3H)isobenzofuranone, 3,6-dimethoxyfluoran, 3,7-bis(dimethylamino)-10-benzoylphenothiazine, 3-diethylamino-7,8-benzofluoran, 3,3-bis)1-n-butyl-2-methyl-indol-3-yl) phthalide, 3,3-bis(1-ethyl-2-methyl-indol-3-yl)phthalide. Many other leuco dyes known to those skilled in the art may be used. The dye is typically present in particulate form, preferably as particles in the micron size range for adequate resolution as known by those skilled in the art.

The acidic developer substance comprises an organic acidic material, optionally treated with a metal such as zinc or magnesium. Examples of materials which may be used include bisphenol A, 4,4′-dihydroxydiphenyl sulfone, phenolic condensation products, salicylic acid derivatives and their zinc salts, salicyloyl salicylate, para-benzyl hydroxy benzoate, sulfonylurea derivatives such as N-p-toluenesulfonyl-N′-phenylurea, 4,4′-bis(p-toluenesulfonylamino-carbonylamino)diphenylmethane, and various low melting point organic acids or their esters.

The polymeric binder of the image layer, for processing purposes, is preferably at least partly water-soluble or water dispersible. It comprises one or a mixture of resinous materials which act to hold the other constituents of the layer together. The preferred binder material is polyvinyl alcohol. Other known binders which may be used include ployvinylpyrrolidone, polyacrylamide, modified celluloses and starches. Latex polymers such as acrylic latex and, polystyrene-butadiene latex, polyvinylacetate copolymer latex polyvinylidene chloride copolymer latex are also useful, particularly when used together with water soluble polymers.

The neutralizing agent contained in the layer may comprise a neutral colored, water-insoluble finely divided particulate material such as titanium dioxide, magnesium carbonate or calcium carbonate. In addition to the foregoing, the layer may also include inert fillers, dispersants, anti-stats, surfactants, wetting agents, preservatives and defoaming agents present in minor amounts as needed.

Generally speaking, the proportion of components based on solids content present in the image layer may range from about 10 to 50% by weight of polymer binder, from about 5 to 50% by weight of dye and 10 to 60% by weight of acidic developer The layer may also contain about 5-30 wt % of neutralizing agent such as calcium carbonate, 0-20 wt % of a filler such as talc, silica, and the like, and also up to 50 wt %, on a dry weight basis, of a SBR or acrylic based latex adhesive to improve adhesion of the image layer to the transparent sheet or to backing layers subsequently applied to the image layer.

The image layer is formulated by mixing or milling separate aqueous dispersions, one containing polymer and the chromogenic dye and the other containing polymer and the acidic developer, along with other conventional ingredients which may be included in the image layer composition. These dispersions are then mixed and applied to the transparent sheet material and dried. The coating thickness on a dry weight basis generally ranges from about 1 to 10 microns.

Examples of conventional materials, i.e. binders, dyes and developers, which may be used in forming the thermal imaging layer may be found in U.S. Pat. Nos. 3,445,261, 4,032,690, 4,370,370, 4,885,271, and 4,898,849, the complete disclosures of which patents are incorporated herein by reference.

As indicated above, the thermal image layer may also comprise two or more layers laid down adjacent to one another, one layer containing the chromogenic dye and the other layer containing the acidic developer. Heated portions of these layers will tend to intermix when heat is applied in image configuration. An example of such a two-layer system is found in U.S. Pat. No. 5,851,951, the complete disclosure of which is incorporated herein by reference. It is also within the scope of the invention to provide two or more adjacent image layers which each contains the dye and developer, but in different proportions. One or both of these layers may also contain latex adhesive materials, in which case a layer may also serve as adhesive layer 18 shown in FIG. 2.

In another embodiment of this invention it has been found that the additional inclusion of one or a mixture of heat fusible crystalline compounds (thermal solvents and thermal non-solvents melting at different temperatures) in the image layer (16) and optionally in the adhesive layer (18) improves the heat responsiveness and image density of these layers while maintaining a high storage stability against fog. The thermal solvent is a crystalline material which, after melting by the application of heat, is a good solvent for the leuco dye and/or the developer Typically their melting points are lower than the melting points of the dyes or the developers. A non-solvent in this invention is a material typically having a melting point lower than the thermal solvent and which in its liquid form is not a solvent for either the dye or the developer. The non-solvent behaves as a heat transfer fluid to transfer heat efficiently and uniformly from the thermal head of the printer to the image layer and optional adhesive layer coatings present adjacent the support layer.

Typical thermal solvents which melt at temperatures of at least about 80° C. include bisphenol A diacetate (BPADA), diphenyl phthalate, dicyclohexyl phthalate, diphenyl oxalate, benzyl oxynaphthalene, 1-hydroxy-2-naphthoate, rosin and m-terphenyl derivatives, as well as many of the heat meltable crystalline compounds disclosed at column 8 of U.S. Pat. No. 4,885,271.

Typical thermal non-solvents which melt at temperatures below the melting temperature of the thermal solvent used include 1,12-dihydroxydodecane, paraffin wax, bee wax, fatty acid, fatty acid amide stearic acid, steramide, zinc stearate and more preferably hindered phenols such as 2,6-di-t-butyl-4-methylphenol (BHT), thiodiethylene hydrocinnamate (IRGANOX™ 1035 from Ciba-Geigy Corp.) tetrakis methane (IRGANOX™ 1010 from Ciba Geigy Corp.) and like materials such as described on columns 9, 10 and 11 of U.S. Pat. No. 4,885,271 Waxy materials are less preferred since they may cause adhesion problems when the base layer (20) is laminated to the adhesive layer (8) or the image layer (16).

When present, the thermal solvents and non-solvents may be used at levels in the range of about 5-200 weight %, based on the weight of the acidic developer, and each or both may comprise from about 1 to 30% by weight, on a dry weight basis, of the weight of the layer in which they are incorporated.

Adhesive layer (18) is prepared using an aqueous latex of a pressure sensitive adhesive polymer such as rubber-based (SBR) or acrylic-based polymer material, polyvinylacetate copolymers, ethylene/vinylacetate copolymers and similar adhesive materials. These adhesives are commercially available such as those distributed under the NACOR® brand by National Starch Corp. The composition may also contain surfactants, wetting agents, thickening agents, fillers and one or more water soluble polymers such as polyvinyl alcohol to facilitate the application of and the adhesion of this layer to other layers. The latex adhesive present in adhesive layer (18) may also be present in image layer (16), as described above

In a preferred embodiment of this invention, adhesive layer (18) may also contain from about 1 to 30% preferably 3 to 20% by dry weight of one or both of the thermal solvents and thermal non-solvents described above. The presence of these materials in the adhesive layer tends to improve the printing speed and image quality while maintaining the heat stability of the recording sheet. The thickness of adhesive layer (18) may range from about 1 to 10 microns.

In yet another embodiment of the invention, judicious selection of chromogenic dyes in terms of the particular color produced when developed allows one to prepare recording sheets which are useful in color proofing applications. Thus, where the color-producing image layer contains one or a combination of dyes having a color from the group of colors including cyan, magenta, yellow and black, then, by stacking a plurality of recording papers, color images can be obtained. For example, if a first recording sheet utilizes color producing layer with magenta color, a second recording sheet utilizes a color producing layers with cyan color, a third recording sheet utilizes a color producing layer with yellow color, and optionally a fourth recording sheet utilizes a color producing layers with black color, an image can be formed with each required color of the image being printed on the corresponding recording paper and then the plurality of recording papers can be stacked on top of each other to produce a full color image. Many of the dyes listed at column 4, line 53 through column 5, line 42 of U.S. Pat. No. 5,851,951 and in U.S. Pat. Nos. 4,885,271, 4,473,831 and 4,580,153 are capable of producing these diverse colors when developed.

In the preferred embodiment of this invention, the heat sensitive recording sheet comprises the embodiment shown in FIG. 2 wherein thermal slip layer (14) has a dry thickness in the order of about 0.5 to about 2 microns, transparent support layer (12) is biaxially oriented PET sheet having a thickness of about 3 to 8 microns, color-producing layer (16) has a thickness of about 2 to 6 microns and adhesive layer (18) has a thickness of about 1 to 4 microns. The preferred composition of color-producing layer 16 on a dry weight basis is as follows

| | | | |
|---|---|---|---|
| 1. | Water Soluble Binder (PVA) | - | 5-20 wt. % |
| 2. | Dye Dispersion | - | 5-20 wt. % |
| 3. | Developer Dispersion | - | 15-60 wt. % |
| 4. | Thermal solvent Dispersion | - | 0-20 wt. % |
| 5. | Non-solvent Dispersion | - | 0-20 wt. % |
| 6. | Filler Dispersion (CaCO3) | - | 0-10 wt. % |
| 7. | Latex Adhesive | - | 0-30 wt. % |

The preferred composition of adhesive layer 18 on a dry weight basis is as follows:

| | | | |
|---|---|---|---|
| 1. | Water Soluble Binder (PVA) | - | 0-20 wt. % |
| 2. | Dye Dispersion | - | 0-5 wt. % |
| 3. | Developer Dispersion | - | 0-30 wt. % |
| 4. | Thermal solvent dispersion | - | 0-20 wt. % |
| 5. | Non-solvent Dispersion | - | 0-20 wt. % |
| 6. | Filler Dispersion (CaCO3) | - | 0-20 wt. % |
| 7. | Latex Adhesive | - | 30-70 wt. % |

In the preferred embodiments of the invention, the adhesive layer (18) does not contain either the leuco dye or the developer.

The heat sensitive recording sheet also includes a second opaque or transparent sheet material (20) which is bonded to the heat sensitive color-producing layer either directly or through adhesive layer (18). This sheet material may comprise a cellulose-based material such as paper, cardboard, or other opaque material, or a transparent plastic sheet material of the type described above used for the support layer (12). The thickness of this sheet material will generally range from about 1 to 7 mil, or about 25-180 microns. Transparent sheets are particularly useful in color proofing applications, whereas opaque sheets are useful for making labels, stickers, and computer print-out paper.

On the back of sheet layer (20) may be disposed a coating (22) containing an adhesive, preferably a pressure sensitive adhesive. This adhesive layer may comprise one or more conventional polymers selected from the group consisting of SBR or SBS rubber-based adhesive, acrylic-based adhesive, a polyvinylacetate-based adhesive and like materials, and may be the same type of adhesive as present in adhesive layer 18. A peelable disposable backing sheet consisting of a base sheet and a non-sticking silicone or wax layer formed thereon for facilitating peeling of the backing sheet off the adhesive layer may be attached to the adhesive layer to allow proper handling of the finished recording sheet. The presence of the adhesive layer (22) and peelable backing sheet are not required where the heat sensitive recording sheet is used as print-out paper, but is useful where the recording sheet is used as label materials or in color proofing applications.

The various layers described above may be applied to their respective substrates by any of the well known coating techniques. Thus solvent solutions or dispersions, or aqueous dispersions of the coating composition may be applied using knife coating, VARI-BAR coating, slot die coating, meter bar coating, pure blade coating, rod blade coating, short dwell coating, curtain coating, gravure coating and microgravure coating methods.

The final heat sensitive recording sheet may be assembled by any one of several techniques:

A. Contact the color image layer 16 adhered to transparent sheet 12 with paper or plastic substrate 20 and pass this laminate through rolls at a temperature sufficient to soften the thermoplastic polymer component present in color image layer 16 to adhesively laminate substrate 20 to color image layer 16. The temperature of lamination should not be high enough to activate the dye present in layer 16.

B. Coat adhesive layer 18 onto either image layer 16 or support layer 20 or both layers, then laminate the two either by application of pressure alone or heat and pressure

C. Where image layer 16 is comprised of two separate layers (16a and 16b), coat image layer 16a on transparent support sheet 12 and image layer 16b on support layer 20, and then laminate the two image layers together using pressure alone or a combination of heat and pressure.

D. Mix adhesive material and material forming image layer 16 (or 16a and 16b) together to improve the tackiness of image layer 16, then laminate as in B above

The preferred method for forming the composite recording sheet is method B where the adhesive layer is coated only on image layer 16

The following examples are illustrative of the invention

Materials used in the following examples are identified as follows.

| | | |
|---|---|---|
| METHOCEL ™ K15 | - | cellulose-based thickening agent from Dow |
| | | Chemical Corp. |
| AEROSOL ™ OT | - | sodium bis (2-ethylhexyl) sulfosuccinate |
| | | surfactant |
| TRITON ™ X-100 | - | t-octylphenoxypolyethoxyethanol non ionic |
| | | surfactant |
| NACOR ™ 8685 | - | pressure sensitive latex adhesive available |
| | | from National Starch Corp. |
| AIRVOL ™ | - | polyvinyl alcohol from Air Products and |
| | | Chemical Corp. |
| SURFYNTOL ™ 104 | - | 2,4,7,9-tetramethyl-5-decyne-4,7 diol surface |
| | | tension lowering agent from Air Products and |
| | | Chemical Corp. |
| BHT | - | 2,6-di-t-butyl-4-methylphenol |
| | | (thermal non-solvent) |
| BPA | - | bisphenol A (acidic developer) |
| BPADA | - | bisphenol A diacetate (thermal solvent) |

(A) Preparation of Leuco Dye Dispersions 900 grams of glass bead, 190 grams of a leuco dye, 171 grams of 10% PVA 205 solution, 2.33 grams of Aerosol OT-75, 0.67 grams of Triton X100, 1.25 grams of Surfynol 104, and 135 grams of deionized water were charged into an attritor and ground for 4 hours The dispersion was attrited for an additional 14 hours after it was diluted with a solution containing 19 grams of 10% PVA Airvol 205 solution, 2.1 grams of Aerosol OT-75, 0.57 grams of Triton X100, 1.25 grams of Surfynol 104, and 114 grams of deionized water The resultant leuco dye dispersion shows a solid content of about 37-38% and a mean particle size of about 1.5-2 microns as measured by Coulter Counter. Typical leuco dyes which are dispersed in this manner include lactone, fluoran, phenothiazine, and triarylpyridine leuco dyes such as BK 400 and BK 350, S206 from Sofix Corp., and Copikem 4 Black N102-T, Copichem 20 Magenta, Copikem 39 cyan, Copikem 34 Black, Copikem 1 Blue CVL-T, from Hilton Davis, ODB-1 and ODB-2 black leuco dyes from Yamada Chemical, and Pergascript I-3R Yellow leuco dye from Ciba Specialty Chemicals.

(B) Preparation of Dispersion of Developer, Thermal Solvent and Non-solvent

The procedure and formulation are the same as those for leuco dye dispersion, except the leuco dye was replaced by a developer, a thermal solvent or a non-solvent. The composition of the dispersions used in the following examples is shown in Table 1.

TABLE 1
Dispersions (gms)

| | Dye | BHT | BPA | BPADA |
|---|---|---|---|---|
| SoFix B-400 Black Leuco Dye | 190 | — | — | — |
| PVA (10% Aqueous Soln) | 190 | 190 | 190 | 190 |
| Aerosol ™ OT (75% soln) | 4.43 | 4.43 | 4.43 | 4.43 |
| Triton ™ X-100 | 1.24 | 1.24 | 1.24 | 1.24 |
| Surfynol ™ 104 | 2.50 | 2.50 | 2.50 | 2.50 |
| BHT | — | 190 | — | — |
| BPA | — | — | 190 | — |
| BPADA | — | — | — | 190 |
| DI water | 249 | 249 | 249 | 249 |
| Solids (% in H₂O) | 38 | 37 | 37 | 37 |
| Particle Size (microns) | 1.5-2 | 1.5-2 | 1.5-2 | 1.5-2 |

The support layer used in the following examples is an approximately 4.5 microns-thick sheet of biaxially oriented PET coated on one side with an approximately 1 micron-thick slip layer containing a polyurethane resin binder cross-linked with a polyfunctional isocyanate and further containing dispersed therein an amount of slip agent sufficient to provide a relative coefficient of friction between the recording sheet slip layer surface and the thermal printing head of less than 0.35. The slip layer does not become tacky at operating conditions involving temperatures of up to 400° C.

### Example-1

Preparation of Image Coat (IM-1)

7.2 grams of 1% Methocel K15 M solution, 3.6 grams of 2% solution of Aerosol OT, 3.6 grams of 2% solution of Triton X100, 0.96 grams of 75% CaCO₃ dispersion, and 3.05 grams of NACOR 8685 latex (54.3% solid) from National Starch were mixed thoroughly. To the resultant mixture, 3.75 grams of 37% BHT dispersion, 21.92 grams of 37% dispersion of bisphenol A (BPA), and 5.81 grams of 38% dispersion of Sofix B400 black leuco dye were added and mixed homogeneously before coated by a #5 Myrad bar onto the front side of 4 5 micron PET sheet which has a polyurethane thermal lubricant (slip layer) precoated on the back side. The coating was dried for 5 minutes at 50° C. and the coverage was measured to be about 3 gm/m².

Preparation of Adhesive Overcoat (OC-1)

3.2 grams of 1% solution of Methocel K15M, 2.12 grams of 10% solution of PVA Airvol 350, 0.48 grams of 2% solution of Aerosol OT, 0.48 grams of 2% solution of Triton X100, 0.53 grams of 75% CaCO₃ dispersion, and 6.11 grams of NACOR 8685 latex (54.3%) were mixed homogeneously and coated by a #3 Myrad bar onto the dried image coat IM-1 The coated sheet was dried for 5 minutes at 50 ° C. and laminated onto a Butler Deerden 70 glossy paper at room temperature by a pressure roller. The sample was printed by an Atlantek Model 200 thermal test printer equipped with a Kyocera 200 dpi thermal head with a t_{cycle}=6 msec and tₒₙ=2 msec A high quality, durable glossy black image was obtained with Dmax (black)=1 95, Dmin=0 1 and E₅₀(energy required to reach 50% of Dmax)=27 mj/mm² The resultant image shows outstanding resistances to water, oil, plasticizer, and fingerprint. No dye was deposited onto the thermal head after prolonged printing.

### Comparative Example 1-A

The same as Example 1, except a sheet without the thermal resistant slip layer was used The resultant image shows significant defects and very poor uniformity

### Comparative Example 1-B

The image coat IM-1 was coated directly onto glossy paper, dried, and printed. The resultant image shows a very poor resistance to water, oil, or fingerprint and a Dmax=1 3 with significant defects and poor uniformity The thermal head shows a noticeable contamination of black dye after printing about 30 A6 images.

### EXAMPLE 2

2 parts of the image coat IM-1 and 1 part of the overcoat OC-1 were mixed homogeneously and coated by a #10 Myrad bar onto the 4.5 micron PET sheet which has a polyurethane thermal lubricant precoated on the back side. The coating was dried for 5 minutes at 50° C. and the coverage was measured to be about 5 gm/m². The coated sheet was then laminated with a glossy paper at a roller surface temperature of 45° C. The resultant printed sample shows a Dmax=1.06 , Dmin=0.11 and E₅₀=about 24 mj/mm².

### EXAMPLE 3

Preparation of Overcoat-2 (OC-2)

The same as OC-1 except the 6.11 grams of NACOR 8685 latex was replaced by 5.44 grams of NACOR 8685 and 0.98 grams of 37% dispersion of BHT. The overcoat OC-2 was then coated by a #3 Myrad bar onto the dried image coat IM-1, dried, laminated, and printed as described in Example 1. A high quality, durable glossy black image was obtained with Dmax=2.02, Dmin =0.1, and E₅₀=24.4 mj/mm².

### EXAMPLE 4

Preparation of Image Coat-2 (IM-2)

The same as IM-1 except the 0.96 grams of 75% CaCO₃ dispersion, 3.05 grams of NACOR 8685 latex, 3.75 grams of 37% BHT dispersion, and 21.92 grams of 37% BPA dispersion were replaced by 1.34 grams of 75% CaCO₃ dispersion, 2.83 grams of NACOR 8685 latex, 5.07 grams of 37% BHT dispersion, 0.87 grams of 37% BPADA dispersion, and 18.76 grams of 37% BPA dispersion. The image coat IM-2 was coated and dried as described in Example 1 and the coverage was measured to be about 3 gm/m².

### EXAMPLE 5

Preparation of Overcoat-3 (OC-3)

The same as OC-1, except the 0.53 grams of 75% CaCO₃ dispersion and 6.11 grams of NACOR 8685 latex were replaced by 0.37 grams of 75% CaCO₃ dispersion, 5 09 grams of NACOR 8685 latex, 0.98 grams of 37% BHT dispersion, and 0 73 grams of 37% BPADA dispersion The overcoat OC-3 was then coated by a #3 Myrad bar onto the dried image coat IM-2, dried, laminated, and printed as described in Example 1 A high quality, durable glossy black image was obtained with Dmax=2.27, Dmin=0.1, and E₅₀=25 mj/mm²

The composition of the various image and adhesive overcoat layers prepared as described above-is shown in Table 2.

TABLE 2
Image (IM) and Adhesive (OC) layers (gms.)

| | IM-1 | IM-2 | OC-1 | OC-2 | OC-3 |
|---|---|---|---|---|---|
| Methocel ™ K15-M (1% soln) | 7.2 | 7.2 | 3.2 | 3.2 | 3.2 |
| Aerosol ™ OT (2% soln) | 3.6 | 3.6 | 0.48 | 0.48 | 0.48 |
| Triton ™ X-100 (2% soln) | 3.6 | 3.6 | 0.48 | 0.48 | 0.48 |
| CaCO₃ (75% disp) | 0.96 | 1.34 | 0.53 | 0.53 | 0.37 |
| Nacor ™ 8685 (54.3% solid) | 3.05 | 2.83 | 6.11 | 5.44 | 5.09 |
| PVA (10% soln) | — | — | 2.12 | 2.12 | 2.12 |
| Dye Dispersion (38%) | 5.81 | 5.81 | — | — | — |
| BHT Dispersion (37%) | 3.75 | 5.07 | — | 0.98 | 0.98 |
| BPA Dispersion (37%) | 21.92 | 18.76 | — | — | — |
| BPADA Dispersion (37%) | — | 0.87 | — | — | 0.73 |

### EXAMPLE 6

Preparation of Magenta Image Coat

The same as Example 4 except the Sofix leuco dye BK400 in IM-2 was replaced by Hilton Davis Copikem 20 magenta leuco dye. The resultant image is a high gloss durable magenta image with a Dmax (magenta)=2.01, Dmin=0.11, and E₅₀=25.2 mj/mm².

### EXAMPLE 7

Preparation of Cyan Image Coat

The same as Example 6, except the Hilton Davis Copikem 20 magenta leuco dye was replaced by Hilton Davis Copikem 39 cyan leuco dye The resultant image is a high gloss durable cyan image with a Dmax=1 92, Dmin=0.1 and E₅₀=24.7 mj/mm²

### EXAMPLE 8

Preparation of Orange Image Coat

The same as Example 6, except the Hilton Davis Copikem 20 magenta leuco dye was replaced by Ciba Pergascript Orange leuco dye The Dmax is about 1.0 (magenta), Dmin is about 0.1, and E₅₀ is about 25 mj/mm².

### EXAMPLE 9

Preparation of Yellow Image Coat

The same as Example 6, except the Hilton Davis Copikem 20 magenta leuco dye was replaced by Ciba Pergascript Yellow I-3R leuco dye, and the BPA dispersion was replaced by 4,4′-dihydroxydiphenyl sulphone (BPS) dispersion, prepared as described in (B) above. The Dmax (yellow) is 1.06, Dmin is 0.11, and E₅₀ is about 27 mj/MM².

What is claimed is:

1. A heat sensitive recording sheet comprising:
a) a first support layer comprising transparent sheet material;
b) a thermal slip layer disposed on one surface of said first support layer;
c) a heat sensitive color-producing layer disposed on the opposite surface of said first support layer; and
d) a second opaque or transparent sheet material bonded to said heat sensitive color-producing layer.

2. The recording sheet of claim 1 further comprising an adhesive layer disposed between said heat sensitive color-producing layer and said second sheet material.

3. The recording sheet of claim 1 wherein said second sheet material has a pressure sensitive adhesive layer on the surface opposite said color-producing layer.

4. The recording sheet of claim 1 wherein said color-producing layer comprises a leuco dye and an acidic developer dispersed in a thermoplastic polymer binder.

5. The recording sheet of claim 4 wherein said thermoplastic polymer is at least partially water-soluble.

6. The recording sheet of claim 1 wherein said thermal slip layer comprises a lubricating slip agent dispersed in a thermoset polymer binder.

7. The recording sheet of claim 1 wherein said first support layer comprises polyethylene terephthalate film.

8. The recording sheet of claim 1 wherein said second sheet material comprises paper

9. The recording sheet of claim 1 wherein said second sheet material comprises a transparent sheet.

10. The recording sheet of claim 1 wherein said first support layer has a thickness in the range of about 0.5 to 50 microns, said slip layer has a thickness in the range of about 0.1 to 5 microns, said color-producing layer has a thickness in the range of about 1 to 10 microns and said second sheet material has a thickness in the range of about 25 to 180 microns.

11. The recording sheet of claim 5 wherein said thermoplastic polymer binder comprises a mixture of said polymer and a pressure sensitive polymeric adhesive material

12. The recording sheet of claim 4 wherein said color-producing layer further contains at least one compound selected from the group consisting of compounds having a melting point of at least about 80° C. which are solvents for said leuco dye and/or said developer after melting, compounds having a melting point below the melting point of said solvents and which are non-solvents for said leuco dye and said developer after melting, and mixtures thereof.

13. A heat sensitive recording sheet comprising:
a) a first support layer comprising transparent sheet material,
b) a thermal slip layer disposed on one surface of said first support layer,
c) a heat sensitive color-producing layer disposed on the opposite surface of said first support layer; said color-producing layer comprising a leuco dye and an acidic developer dispersed in a thermoplastic polymer binder;
d) an adhesive layer disposed on the surface of said heat sensitive color-producing layer opposite said first support layer; and
e) a second opaque or transparent sheet material bonded to said adhesive layer; at least one of said color-producing layer and said adhesive layer containing a compound having a melting point of at least about 80° C. which is a solvent for said leuco dye and/or said developer after melting.

14. The recording sheet of claim 13 wherein at least one of said color-producing layer and said adhesive layer further contains a compound having a melting point below the melting point of said solvent and which is a non-solvent for said leuco dye and said developer after melting.

15. A process for producing a heat sensitive recording sheet comprising:
a) applying a coating composition having slip properties to one surface of a transparent sheet material to form a thermal slip layer;
b) applying a coating comprising heat sensitive color-producing composition to the opposite surface of said sheet material to form a heat sensitive color-producing layer; and
c) adhesively bonding a second opaque or transparent sheet material to said heat sensitive color-producing layer.

16. The process of claim 15 wherein an adhesive layer is interposed between said color-producing layer and said second opaque or transparent sheet material prior to said bonding
